(19) United States
(12) Patent Application Publication
(10) Pub. No.: US 2005/0041804 A1
(43) Pub. Date: Feb. 24, 2005

(54) Film projection security method and apparatus

(75) Inventors: John C. Mese, Cary, NC (US); Nathan J. Peterson, Raleigh, NC (US); Rod D. Waltermann, Durham, NC (US); Arnold S. Weksler, Raleigh, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/642,992

(22) Filed: Aug. 18, 2003

(51) Int. Cl. G09C 3/00

(52) U.S. Cl. 380/54

(57) ABSTRACT

A method and system for preventing unauthorized copying of a film using a recording device is disclosed. The film is played using a projector residing on a first side of the screen. At least one image from the film is thus displayed on a screen. The method and system include providing at least one signal to the screen from a second side of the screen. The second side of the screen is opposite to the first side. The signal(s) are preferably invisible to the human eye but visible to a recording device used in copying the film. The signal(s) are also sufficient to wash out at least a portion of the image to the recording device.

### FIELD OF THE INVENTION

The present invention relates to film projection, and more particularly to a method and system for protecting films from unauthorized copying during projection.

### BACKGROUND OF THE INVENTION

FIG. 1 is a diagram of a conventional system 10 for displaying a film, for example in a commercial movie theater. The conventional system 10 includes at least one projector 12 and a screen 14. Note that other components, for example seats for viewers, are not shown for clarity. The operator of the theater uses the projector(s) 12 to project the film onto the screen 14. Consequently, moviegoers can view the film.

Although the conventional system 10 functions, one of ordinary skill in the art will readily recognize that unauthorized copying, or piracy, of films is possible. Such unauthorized copying of films may be prevalent and may result in a substantial amount of lost revenues for filmmakers, studios, operators of movie theaters, and others involved in the film industry.

FIG. 1 also depicts an individual 20 engaged in unauthorized copying of the film being shown by the conventional system 10. The individual 20 may be a moviegoer or other individual viewing the film. The individual 20 utilizes an image capture device 22, such as a video camera or other device capable of recording the film. The individual 20 uses the image capture device 22 to record the images appearing on the screen and, in general, the corresponding sounds. Upon the individual 20 exiting, the image capture device 22 retains an unauthorized copy of the film that was shown using the system 20. The individual 20 may then distribute the unauthorized copy, for example via the Internet, to others. Purchasers of the unauthorized copy need not view the film in the theater or by other lawful means, for example by renting a video or DVD from an authorized source.

Some conventional systems to protect unauthorized copying do exist. For example, certain systems project infrared light from the same side of the screen 14 as the projector 12. Such systems might add an infrared light source (not shown) to the projector(s) 12 or place an infrared light source adjacent to the projector(s) 12. Certain image capture devices 22, such as video cameras, are sensitive to infrared light. For example, certain video cameras use infrared light for focusing. The infrared light washes out portions of the image(s) for the image capture device 22. In other words, the infrared light renders the image invisible (or barely visible) to the image capture device 22. This washing out is typically accomplished by providing the infrared light at a high enough intensity to reduce or substantially eliminate any contrast in the images on the screen 14. Thus, the image capture device 22 should capture an image that is essentially unrecognizable to a viewer of the unauthorized copy.

Although such conventional systems may prevent some unauthorized copying, one of ordinary skill in the art will readily recognize that there are substantial drawbacks. Although the screen 14 reflects light, there are losses associated with the reflections. Consequently, a higher intensity infrared light source may need to be used. Furthermore, because the reflected infrared light might be correlated, for example by its polarization, it may be possible for the individual 20 to filter the infrared light from the image capture device 22. Consequently, unauthorized copying may proceed substantially unabated.

Accordingly, what is needed is a system and method for more efficiently preventing unauthorized copying of films. The present invention addresses such a need.

### SUMMARY OF THE INVENTION

The present invention provides a method and system for preventing unauthorized copying of a film using a recording device. The film is played using a projector residing on a first side of the screen. At least one image from the film is thus displayed on a screen. The method and system include providing at least one signal to the screen from a second side of the screen. The second side of the screen is opposite to the first side. There is at least one signal that is preferably invisible to the human eye but visible to a recording device used in copying the film. The signal(s) are also sufficient to wash out at least a portion of the image to the recording device.

According to the system and method disclosed herein, the present invention provides a mechanism for efficiently preventing unauthorized copying of a film being shown.

### BRIEF DESCRIPTION OF THE DRAWINGS

FIG. 1 is a diagram of a conventional system for projecting a film.

FIG. 2 is a diagram of one embodiment of a system in accordance with the present invention for protecting a film from unauthorized copying.

FIG. 3 is a high-level flow chart depicting one embodiment of a method in accordance with the present invention for protecting a film from unauthorized copying.

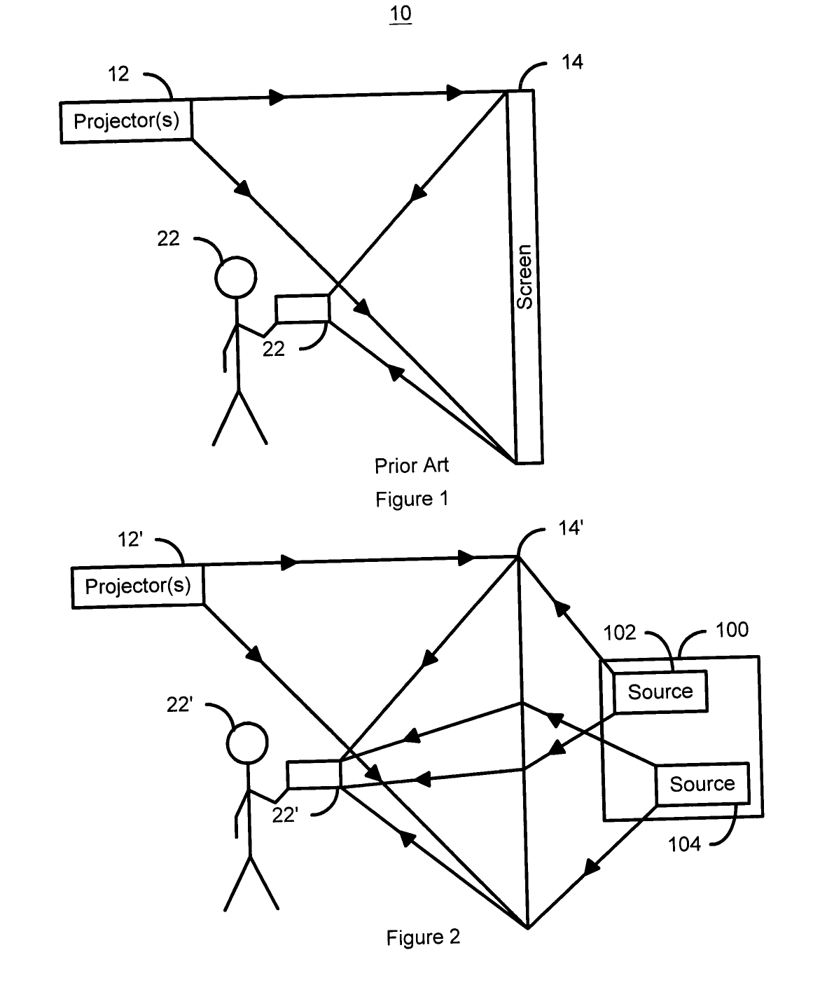

### DETAILED DESCRIPTION OF THE INVENTION

The present invention relates to an improvement in protection of films. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present invention provides a method and system for preventing unauthorized copying of a film using a recording device. The film is played using a projector residing on a first side of the screen. At least one image from the film is thus displayed on a screen. The method and system include providing at least one signal to the screen from a second side of the screen. The second side of the screen is opposite to the first side. The signal(s) are preferably invisible to the human eye but visible to a recording device used in copying the film. The signal(s) are also sufficient to wash out at least a portion of the image to the recording device.

The present invention will be described in terms of particular wavelengths of light and mechanisms for providing a signal. However, one of ordinary skill in the art will readily recognize that this method and system will operate other signals capable of washing out images for different and/or additional image capture devices. In addition, the present invention is described in the context of washing out images to an image capture device. However, one of ordinary skill in the art will readily recognize that the method and system preferably function effectively for multiple video camera devices.

To more particularly illustrate the method and system in accordance with the present invention, refer now to FIG. 2, depicting one embodiment of a system 100 in accordance with the present invention for protecting a film from unauthorized copying. The system 100 is used in conjunction with a conventional system for displaying a film. Consequently, the system 100 is depicted in the context of a system 10′ for displaying a film. Thus, certain elements depicted in FIG. 2 are labeled in an analogous manner to portions of the conventional system 10′. For example, FIG. 2 depicts at least one projector 12′ and screen 14′. Also shown is an individual 20′ holding an image capture device 22′ in an attempt to copy the film being shown.

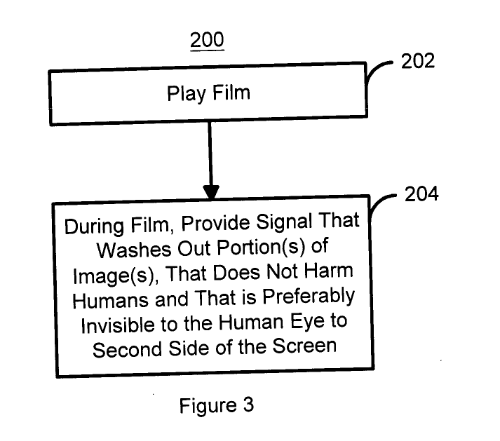

FIG. 3 is a high-level flow chart depicting one embodiment of a method 200 in accordance with the present invention for protecting a film from unauthorized copying. The method 200 is described in conjunction with the system 100.

Referring to FIGS. 2 and 3, the system 100 includes one or more sources. In the embodiment shown, the system 100 includes sources 102 and 104. In another embodiment, a different number of sources could be used. Furthermore, in another embodiment, each source might provide more than one signal. The sources 102 and 104 may also be placed at different distances and/or have different spreads for the signals. The sources 102 and 104 are placed on a side of the screen opposite to the projector(s) 12′. For clarity, the side of the screen 14′ facing the projector(s) 12′ is termed the first side, while the opposite side of the screen 14′ facing the sources 102 and 104 is termed the second side. In a preferred embodiment, the sources 102 and 104 are infrared light sources.

The desired film is played, via step 202. Step 202 is preferably performed by projecting the film onto the screen 14′ using the projector(s) 12′. During at least a portion of the film, the sources 102 and 104 provide signal(s) to the second side of the screen 14, via step 204. In a preferred embodiment, the signal(s) are provided during all of the film. The signal(s) provided to the screen are sufficient to wash out portions the image(s) on the screen 14′. However, in another embodiment, one or more portions of the image(s) may be washed out. For example, only a central portion of the image might be washed out. Alternatively, the central portion and portions near the edges of the screen 14′ may be washed out. In the embodiment shown, the sources 102 and 104 provide signals having an intensity and breadth such that all of the image(s) on the screen 14′ are washed out. Furthermore, in a preferred embodiment, the signals provided by the sources 102 and 104 have an intensity that renders transparent the portions of the screen 14′ through which the signal is transmitted. Moreover, the signals provided in step 204 are preferably uncorrelated. For example, the signals provided to the second side of the screen 14′ contain multiple polarizations and, preferably are unpolarized. In addition, the signals provided in step 204 are preferably invisible to the human eye and do not do injury to the human eye. However, in an alternate embodiment, the signals may be visible to the human eye. In either case, the signals are configured such that they do not adversely affect the humans' perception of the film.

Because the sources 102 and 104 provide signal(s) to the second side of the screen 14′, the individual 20′ may not be able to engage in unauthorized copying of the film being shown. The signal(s) are such that portion(s) of the images are washed out for the image capture device 22′. For example, if the image capture device 22′ includes one or more video cameras, the video cameras are typically sensitive to infrared light. Furthermore, CCDs are typically highly sensitive to infrared light. Thus, the sources 102 and 104 may provide infrared light signals to the second side of the screen 14′. In a preferred embodiment, the light signals include a number of wavelengths in the infrared range. The infrared light signals are read by the image capture device 22′. Because of the intensity and/or breadth of the infrared signals, the image(s) captured by the image capture device 22′ are washed out, or substantially unrecognizable as part of the film being shown. In a preferred embodiment, the screen 14′ is rendered transparent. Thus, the image capture device 22′ would capture images that are blank. As a result, the individual 20′ is substantially prevented from engaging in unauthorized copying.

Thus, the system 100 and method 200 prevent unauthorized copying. Because the sources 102 and 104 provide signals to the second side of the screen 14′ and are preferably unpolarized, the individual 20′ should be unable to filter the signals from the image capture device 22′. In addition, the signals provided, such as infrared light, are visible to the image capture device 22′ but preferably invisible and harmless to humans. Thus, unauthorized copying can be prevented safely and without adversely affecting image quality for viewers of the film. Lower intensity signals can also be used because reflections off of the screen 14′ need not be accounted for. Instead, the image capture device 22′ receives signals transmitted by the screen 14′. Moreover, the screen 14′ may be rendered transparent using the system 100 and method 200, providing extremely effective prevention against unauthorized copying. Consequently, using the method 100 and system 200, those in the film industry may not be subjected to losses due to unauthorized copying. Furthermore, because infrared A method and system has been disclosed for protecting a film from unauthorized copying. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for preventing unauthorized copying of a film using a recording device, the film being played using a projector, at least one image from the film being displayed on a screen, the projector residing on a first side of the screen, the method comprising the steps of:
providing at least one signal to the screen from a second side of the screen, the second side being opposite to the first side, the at least one signal being visible to a recording device used in copying the film, the at least one signal being sufficient to wash out at least a portion of the image to the recording device.

2. The method of claim 1 wherein the at least one signal further includes a light signal.

3. The method of claim 1 wherein the at least one signal includes infrared light.

4. The method of claim 1 wherein the providing step further includes the step of:
providing the at least one signal at an intensity and breadth sufficient to wash out the entire image to the recording device.

5. The method of claim 1 wherein the providing step further includes the step of:
providing the at least one signal at an intensity sufficient to render the screen transparent to the recording device.

6. The method of claim 1 wherein the providing step further includes the step of:
projecting the at least one signal to the screen from the second side of the screen.

7. The method of claim 1 wherein the recording device includes an image capture device.

8. The method of claim 7 wherein the image capture device includes a video camera.

9. The method of claim 1 wherein the signal is invisible to the human eye.

10. A system for preventing unauthorized copying of a film using a recording device, the film being played using a projector, at least one image from the film being displayed on a screen, the projector residing on a first side of the screen, the method comprising the steps of:
at least one source residing on a second side of the screen, the second side of the screen being opposite to the first side, the at least one source providing to the screen at least one signal invisible to the human eye but visible to a recording device used in copying the film, the at least one signal being sufficient to wash out at least a portion of the image to the recording device.

11. The system of claim 10 wherein the at least one source is at least one light source and wherein the at least one signal further includes at least one light signal.

12. The system of claim 10 wherein the at least one signal includes infrared light.

13. The system of claim 10 wherein the at least one source provides the at least one signal at an intensity and breadth sufficient to wash out the entire image to the recording device.

14. The system of claim 10 wherein the at least one source further provides the at least one signal at an intensity sufficient to render the screen transparent to the recording device.

15. The system of claim 10 wherein the at least one source further projects the at least one signal to the screen from the second side of the screen.

16. The system of claim 10 wherein the recording device includes an image capture device.

17. The system of claim 16 wherein the image capture device includes a video camera.

18. The system of claim 10 wherein the signal is invisible to the human eye.
